(19) United States
(12) Patent Application Publication
(10) Pub. No.: US 2026/0181497 A1
(43) Pub. Date: Jun. 25, 2026

(54) A METHOD FOR PROCESSING INFORMATION OF A BASE STATION AND SYSTEM, AND RELATED DEVICES

(71) Applicant: CHINA TELECOM CORPORATION LIMITED, Beijing (CN)

(72) Inventors: Yuxiang JIANG, BEIJING (CN); Xiaojie ZHU, BEIJING (CN); Jiannan OU, BEIJING (CN); Li PENG, BEIJING (CN); Jinlan MA, BEIJING (CN)

(21) Appl. No.: 19/124,471

(22) PCT Filed: May 26, 2023
(86) PCT No.: PCT/CN2023/096531

§ 371 Date: Apr. 25, 2025

(30) Foreign Application Priority Data
Oct. 28, 2022 (CN) 202211333444.8

(51) Int. Cl. H04W 36/00; H04W 36/08

(52) U.S. Cl. CPC H04W 36/00835; H04W 36/08

(57) ABSTRACT

The present disclosure discloses a method for processing information of a base station and system, and related devices, and relates to the technical field of communication technology. The method of the present disclosure is executed by a network access control function (NACF), including: receiving base station status information sent from each of a plurality of base stations; determining a handover priority for the each of the plurality of base stations based on the base station status information of the each of the plurality of base stations; and sending to the each of the plurality of base stations the handover priority of a relevant base station of the each of the plurality of base stations.

### CROSS-REFERENCE TO RELATED APPLICATIONS

The present disclosure is a U.S. National Stage Application under 35 U.S.C. § 371 of International Patent Application No. PCT/CN2023/096531, filed on May 26, 2023, which is based on and claims priority of Chinese application for invention No. 202211333444.8, filed on Oct. 28, 2022, the disclosure of which is hereby incorporated into this disclosure by reference in its entirety.

### TECHNICAL FIELD

The present disclosure relates to a technical field of communication technology, and in particular to a method for processing information of a base station, and a system, and related devices.

### BACKGROUND

A satellite base station integrate satellite network and mobile communication network technology to provide mobile network signal for a terminal, enabling the terminal to make voice calls, transmit data, etc. via satellite communication.

The satellite base station is different from a terrestrial base station, as its movement can cause changes in its status (e.g., location).

### SUMMARY

According to some embodiments of the present disclosure, there is provided a method for processing information of a base station, which is performed by a network access control function (NACF) and comprises: receiving base station status information sent from each of a plurality of base stations; determining a handover priority for the each of the plurality of base stations based on the base station status information of the each of the plurality of base stations; and sending to the each of the plurality of base stations the handover priority of a relevant base station of the each of the plurality of base stations.

In some embodiments, the base station status information comprises: at least one of constellation trajectory, load information, base station location, satellite ephemeris information, or quality of service information.

In some embodiments, the method further comprises: storing the base station status information and the handover priority of the each of the plurality of base stations.

In some embodiments, the method further comprises: receiving updated base station status information sent from one or more updated base stations, wherein the one or more updated base stations are part or all of the plurality of base stations; determining an updated handover priority for the each of the plurality of base stations based on the updated base station status information of each of the one or more updated base stations and the base station status information of each non-updated base station; and sending to the each of the plurality of base stations the updated handover priority of the relevant base station of the each of the plurality of base stations.

In some embodiments, the method further comprises: storing the updated base station status information and the updated handover priority of the each of the plurality of base stations to update the stored base station status information and the handover priority of the each of the plurality of base stations.

In some embodiments, the method further comprises: receiving an information retransmission request sent from a source base station of handover, wherein the source base station is a base station among the plurality of base stations, and the information retransmission request is configured to request the base station status information of a relevant base station of the source base station; querying the base station status information of the relevant base station of the source base station; and sending queried information to the source base station to enable the source base station to select a target base station for handover based on received information.

In some embodiments, the relevant base station of the each of the plurality of base stations comprise: one or more nearby base stations within a predetermined distance from the each of the plurality of base stations.

In some embodiments, the information retransmission request is sent from the source base station in a case where a current handover policy is inconsistent with a policy generating the handover priority of the each of the plurality of base stations.

According to other embodiments of the present disclosure, there is provided a method for processing information of a base station, which is performed by a base station and comprises: sending base station status information to a network access control function (NACF), wherein the base station status information is used by the NACF to determine a handover priority for each of a plurality of base stations; and receiving and storing the handover priority of a relevant base station of the each of the plurality of base stations sent from the NACF to update stored handover priority of the relevant base station.

In some embodiments, the method further comprises: sending updated base station status information to the NACF, wherein the updated base station status information is used by the NACF to determine an updated handover priority for the each of the plurality of base stations; and receiving and storing the updated handover priority of the relevant base station sent from the NACF to update the stored handover priority of the relevant base station.

In some embodiments, the method further comprises: in a case where a handover decision is made and a current handover policy is inconsistent with a policy generating the handover priority of the each of the plurality of base stations, sending an information retransmission request to the NACF, wherein the information retransmission request is configured to request the base station status information of the relevant base station of the base station; receiving the base station status information of the relevant base station returned by the NACF; and selecting a target base station for handover based on the base station status information of the relevant base station.

In some embodiments, the method further comprises: in a case where a handover decision is made, selecting a target base station for handover based on the handover priority of the relevant base station.

In some embodiments, the relevant base station of the each of the plurality of base stations comprise: one or more nearby base stations within a predetermined distance from the each of the plurality of base stations.

According to still other embodiments of the present disclosure, there is provided a network access control function, comprising: a processor; and a memory coupled to the processor for storing instructions that, when executed by the processor, cause the processor to perform a method for processing information of a base station provided in any one of the foregoing embodiments.

According to still other embodiments of the present disclosure, there is provided a system for processing information of a base station, comprising: a network access control function provided in any one of the foregoing embodiments, and one or more base stations provided in any one of the foregoing embodiments.

According to further embodiments of the present disclosure, there is provided a base station, comprising: a processor; and a memory coupled to the processor for storing instructions that, when executed by the processor, cause the processor to perform a method for processing information of a base station provided in any one of the foregoing embodiments.

Other features and advantages of the present disclosure will become clear from the following detailed description of exemplary embodiments of the present disclosure with reference to the accompanying drawings.

### BRIEF DESCRIPTION OF THE DRAWINGS

In order to provide a clearer explanation of the technical solutions in the embodiments of the present disclosure or the prior art, a brief introduction will be given below to the accompanying drawings required by descriptions of the embodiments or the prior art. Obviously, the drawings in the following descriptions are only some of the embodiments of the present disclosure. Those skilled in the art can also obtain other drawings based on these accompanying drawings with no creative work required.

FIG. 1 is a flowchart of a method for processing information of a base station provided in some embodiments of the present disclosure.

FIG. 2 is a flowchart of a method for processing information of a base station provided in some other embodiments of the present disclosure.

FIG. 3 is a flowchart of a method for processing information of a base station provided in some still other embodiments of the present disclosure.

FIG. 4 is a flowchart of a method for processing information of a base station provided in some further embodiments of the present disclosure.

FIG. 5 is a flowchart of a method for processing information of a base station provided in some further embodiments of the present disclosure.

FIG. 6 is a schematic structure diagram of a network access control function in some embodiments of the present disclosure.

FIG. 7 is a schematic structure diagram of a base station in some embodiments of the present disclosure.

FIG. 8 is a schematic structure diagram of an electronic device in some embodiments of the present disclosure.

FIG. 9 is a schematic structure diagram of an electronic device in some other embodiments of the present disclosure.

FIG. 10 is a schematic structure diagram of a system for processing information of a base station in some embodiments of the present disclosure.

### DETAILED DESCRIPTION

The technical solution in the embodiments of the present disclosure will be clearly and completely described with reference to the accompanying drawings in below. Obviously, the described embodiments are only some of the embodiments of the disclosure rather than the whole embodiments. The following descriptions of at least one exemplary embodiment are merely illustrative in nature and are in no way intended to limit the disclosure, its application or uses. Based on the embodiments in the present disclosure, all other embodiments obtained by those skilled in the art without creative work fall into the protection scope of the present disclosure.

The inventors have found that mobilities of satellites cause changes in a transmission delay over an air interface and a transmission delay between base stations and a core network, making established bearers or channels unable to meet requirements of service and signaling transmission, thereby compromising quality of service. Different services (such as voice, video, data, etc.) have different requirements of the quality of service (such as transmission rate, etc.) of a network. When changes in base station status information affect a performance of the network, it is necessary to ensure the quality of service of communication services through a handover between base stations. Handover methods and procedures between base stations which is defined in a current standard are designed based on terrestrial networks and cannot meet requirements of handovers between satellite base stations or between satellite base stations and terrestrial base stations in a satellite-terrestrial integrated network.

A technical problem to be solved by the present disclosure is: how to improve accuracy of a terminal handover between base stations in a satellite-based mobile communication scenario.

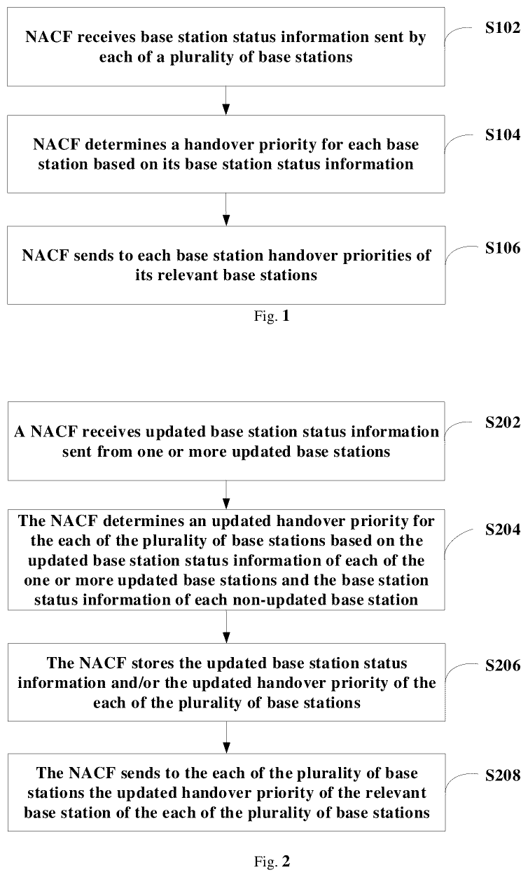

The present disclosure provides a method for processing information of a base station, which will be described below with reference to FIGS. 1-5.

FIG. 1 is a flowchart of a method for processing information of a base station provided in some embodiments of the present disclosure. As shown in FIG. 1, the method of the embodiments comprises: steps S102 to S106.

In step S102, a NACF (Network Access Control Function) receives base station status information sent from each of a plurality of base stations.

The NACF is responsible for information processing of a plurality of base stations within a certain area, and the plurality of base stations comprises satellite base stations or other mobile base stations. Each of the plurality of base stations managed by the NACF can send the base station status information to the NACF. For example, the each of the plurality of base stations can periodically send the base station status information to the NACF.

In some embodiments, the base station status information comprises at least one of constellation trajectory, load information, base station location, satellite ephemeris information, or quality of service (QoS) information. The load information comprises, but is not limited to, the number of currently connected terminals.

In step S104, the NACF determines a handover priority for the each of the plurality of base stations based on the base station status information of the each of the plurality of base stations.

The NACF can calculate the handover priority for the each of the plurality of base stations based on the base station status information of the each of the plurality of base stations. For example, the lighter a load, the higher the handover priority; or the higher the QoS, the higher the handover priority; or, based on the base station location, the satellite ephemeris information, or the constellation trajectory, the closer a base station is to a preset point, the higher the handover priority of the base station is determined.

For example, a score is set corresponding to an information item, the scores of some or all of the information items are weighted to determine a final score, and the handover priority is determined for the each of the plurality of base stations based on the final score of the each of the plurality of base stations. The specific method for determining the handover priority of the each of the plurality of base stations can be set based on actual needs and is not limited to the examples given.

In some embodiments, the NACF stores the base station status information and/or the handover priority of the each of the plurality of base stations. The NACF can generate a base station information table to store the base station status information and/or the handover priority of the each of the plurality of base stations.

In step S106, the NACF sends to the each of the plurality of base stations the handover priority of a relevant base station of the each of the plurality of base stations.

In some embodiments, the relevant base station of the each of the plurality of base stations comprise: one or more nearby base stations within a predetermined distance from the each of the plurality of base stations. The NACF can determine the relevant base station of the each of the plurality of base stations based on at least one of the base station location, the satellite ephemeris information, or the constellation trajectory, and only needs to send the handover priority of the relevant base station to the each of the plurality of base stations. For the each of the plurality of base stations, the handover priority of the relevant base station can be used to select a target base station for handover.

The NACF can also calculate the handover priority of the relevant base station for the each of the plurality of base stations, and then send the handover priority of the relevant base station to the each of the plurality of base station. For example, for each relevant base station of the each of the plurality of base stations, the lighter the load of the relevant base station, the higher the handover priority of the relevant base station; or the higher the QoS of the relevant base station, the higher the handover priority of the relevant base station; or, based on the location, the satellite ephemeris information, or the constellation trajectory of the relevant base station, the closer the relevant base station is to the base station, the higher the handover priority of the relevant base station is determined. For another example, a score is set corresponding to each information item of the relevant base station, and the scores of some or all of the information items are weighted to determine a final score. Based on the final score of the each relevant base station, the handover priority is determined for the each relevant base station.

After the each of the plurality of base stations receives the handover priority of the relevant base station, the each of the plurality of base stations can store the handover priority. For example, the each of the plurality of base stations can generate a local base station handover information table to store the handover priority of the relevant base station.

In the method of the above embodiment, the each of the plurality of base stations sends the base station status information to the NACF. Based on the base station status information of the each of the plurality of base stations, the NACF determines the handover priority for the each of the plurality of base stations and then sends to the each of the plurality of base stations the handover priority of the relevant base station of the each of the plurality of base stations. Based on the method described in the above embodiment, the handover priority of the each of the plurality of base stations is determined based on the base station status information of the each of the plurality of base stations. Further, when handover is required, the each of the plurality of base stations can select a suitable target base station for a terminal based on the handover priority of the relevant base station, thereby improving the accuracy and efficiency of terminal handover between the base stations, meeting handover requirements, and improving the quality of service.

A method for processing information of a base station in some other embodiments of the present disclosure will be described below with reference to FIG. 2.

FIG. 2 is a flowchart of a method for processing information of a base station provided in some other embodiments of the present disclosure. As shown in FIG. 2, the method of the embodiments comprises: steps S202 to S208.

In step S202, a NACF receives updated base station status information sent from one or more updated base stations. The one or more updated base stations are part or all of the plurality of base stations.

Each of a plurality of base stations can periodically send the updated base station status information to the NACF, or send the updated base station status information to the NACF in response to an update in base station status information, or send the updated base station status information to the NACF in response to an update request sent from the NACF.

In step S204, the NACF determines an updated handover priority for the each of the plurality of base stations based on the updated base station status information of each of the one or more updated base stations and the base station status information of each non-updated base station. The NACF can determine an updated handover priority of the each of the plurality of base stations based on the updated base station status information of the each of the one or more updated base stations.

The non-updated base stations are the base stations other than the one or more updated base stations among the plurality of base stations. For the each of the one or more updated base stations, if the relevant base station of the each of the one or more updated base stations include the updated base station, the NACF calculates the updated handover priority for each relevant base station of the each of the one or more updated base stations, and then sends the updated handover priority of the relevant base station to the each of the one or more updated base stations. For the each of the one or more updated base stations, the relevant base station include: one or more nearby base stations within a predetermined distance from the each of the plurality of base stations. For the specific method of determining the updated handover priority, reference can be made to the previous embodiments, which will not be repeated here.

In step S206, the NACF stores the updated base station status information and/or the updated handover priority of the each of the plurality of base stations to update the stored base station status information and/or the handover priority of the each of the plurality of base stations.

The NACF updates the base station status information and the handover priority of the relevant base station using the latest base station status information from the each of the plurality of base stations, and sends the updated handover priority of the relevant base station to the each of the plurality of base stations. The NACF can use the updated base station status information and the updated handover priority of the each of the plurality of base stations to update the base station status information and the handover priority of the each of the plurality of base stations in the base station information table. In addition to updating the handover priority of each of the one or more updated base stations, the handover priorities of other base stations may also be updated. Therefore, it is necessary to store the updated handover priorities of those base stations whose handover priorities have been updated.

In step S208, the NACF sends to the each of the plurality of base stations the updated handover priority of the relevant base station of the each of the plurality of base stations.

Because a location of a base station may change, the relevant base station determined by the NACF for the each of the plurality of base stations may differ from those previously determined by the NACF. The NACF can re-determine the relevant base station of the each of the plurality of base stations based on at least one of the base station location, the satellite ephemeris information, or the constellation trajectory.

The each of the plurality of base stations stores the updated handover priority of the relevant base station to update the stored handover priority of the relevant base station. For example, the each of the plurality of base stations uses the updated handover priority of the relevant base station to update the handover priority of the relevant base station stored in local base station handover information table.

In the method of the above embodiment, the NACF supports updating the base station status information of the each of the plurality of base stations and updating the handover priority of the each of the plurality of base stations. The NACF sends to the each of the plurality of base stations the updated handover priority of the relevant base station, and the each of the plurality of base stations can select a target base station for handover based on the updated handover priority, which may further improve the accuracy of terminal handover between the base stations, meet the handover requirements, and improve the quality of service.

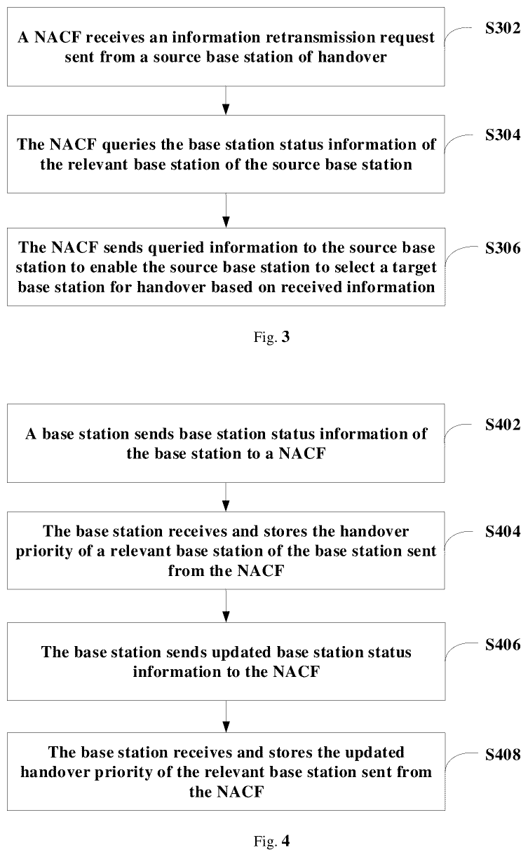

A method for processing information of a base station in some still other embodiments of the present disclosure will be described below with reference to FIG. 3.

FIG. 3 is a flowchart of a method for processing information of a base station provided in some still other embodiments of the present disclosure. As shown in FIG. 3, the method of the embodiments comprises: steps S302 to S306.

In step 302, a NACF receives an information retransmission request sent from a source base station of handover.

The source base station is a base station among the plurality of base stations, and the information retransmission request is configured to request the base station status information of one or more nearby base stations within a predetermined distance from the source base station, i.e., the information retransmission request is configured to request the base station status information of the relevant base station of the source base station.

In some embodiments, the information retransmission request is sent from the source base station in a case where a current handover policy is inconsistent with a policy generating the handover priority of the each of the plurality of base stations. In a case where a handover decision (i.e., a determination of handover) is made by the source base station and the current handover policy is inconsistent with the policy generating the handover priority of the each of the plurality of base stations, the information retransmission request is sent to the NACF.

The current handover policy may be a handover policy required by the service side. For example, if the current handover policy is to select a base station with the minimum load as the target base station, and the policy generating the handover priority for the each of the plurality of base stations is that the higher a QoS of a base station, the higher a handover priority of the base station, then the current handover policy is inconsistent with the policy generating the handover priority of the each of the plurality of base stations. The base station can obtain the current handover policy and the policy generating the handover priority of the each of the plurality of base stations from a policy control function (PCF) and make a judgment.

In step S304, the NACF queries the base station status information of the relevant base station of the source base station.

The NACF can determine the one or more nearby base stations (i.e., the relevant base station) within the predetermined distance from the source base station based on at least one of base station location, satellite ephemeris information, or constellation trajectory, and further query the base station status information of the relevant base station in a base station information table.

In step S306, the NACF sends queried information to the source base station to enable the source base station to select a target base station for handover based on received information.

The source base station can select a base station that meets the current handover policy as the target base station based on the current handover policy and received base station status information of the relevant base station.

In the method of the above embodiment, in a case where a handover is to be made by the source base station, if the current handover policy is inconsistent with the policy generating the handover priority of the each of the plurality of base stations, the information retransmission request is sent to the NACF, and then a target base station that meets the current handover policy is selected based on the received information, thereby improving the accuracy of terminal handover between the base stations, meeting the handover requirements, and improving the quality of service.

A method for processing information of a base station in some embodiments of the present disclosure will be described below with reference to FIG. 4 from the perspective of the base station.

FIG. 4 is a flowchart of a method for processing information of a base station provided in some further embodiments of the present disclosure. As shown in FIG. 4, the method of the embodiments comprises: steps S402 to S408.

In step S402, a base station sends base station status information of the base station to a NACF.

The base station status information is used by the NACF to determine a handover priority for each of a plurality of base stations. For example, the base station status information comprises: at least one of base station location, satellite ephemeris information, constellation trajectory, load information, or quality of service information.

In step S404, the base station receives and stores the handover priority of a relevant base station of the base station sent from the NACF.

In step S406, the base station sends updated base station status information to the NACF.

The updated base station status information is used by the NACF to determine an updated handover priority for the each of the plurality of base stations.

In step S408, the base station receives and stores the updated handover priority of the relevant base station sent from the NACF.

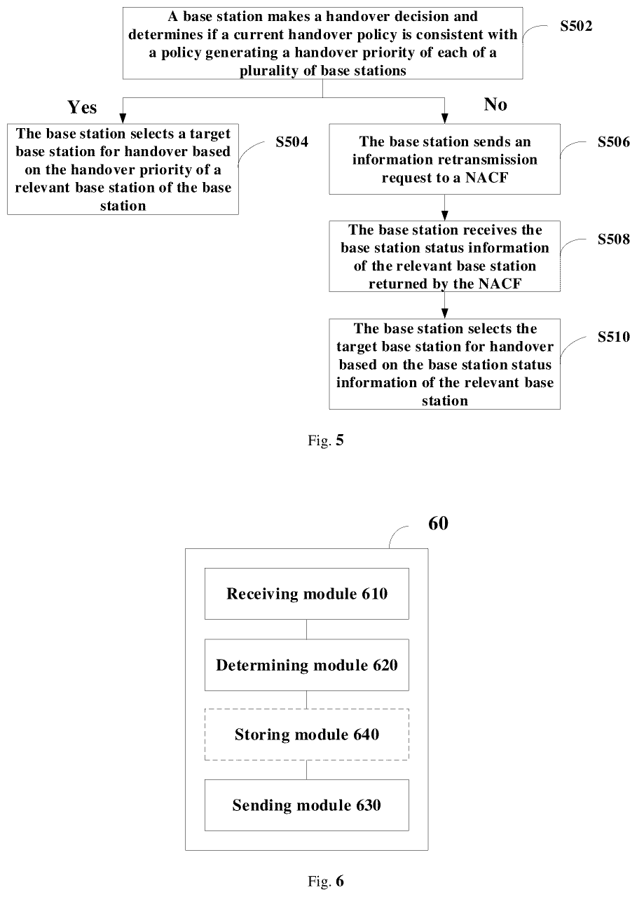

A method for processing information of a base station in some embodiments of the present disclosure will be described below with reference to FIG. 5 from the perspective of the base station.

FIG. 5 is a flowchart of a method for processing information of a base station provided in some further embodiments of the present disclosure. As shown in FIG. 5, the method of the embodiments comprises: steps S502 to S510.

In step S502, a base station makes a handover decision and determines if a current handover policy is consistent with a policy generating a handover priority of each of a plurality of base stations. If consistent, step S504 is performed. Otherwise, step S506 is performed.

In step S504, the base station selects a target base station for handover based on the handover priority of a relevant base station of the base station.

In step S506, the base station sends an information retransmission request to a NACF, wherein the information retransmission request is configured to request the base station status information of the relevant base station of the base station.

In step S508, the base station receives the base station status information of the relevant base station returned by the NACF.

In step S510, the base station selects the target base station for handover based on the base station status information of the relevant base station.

The base station selects a base station that meets the current handover policy as the target base station based on the base station status information of the relevant base station.

The method of the disclosure is applicable to satellite ground fusion networks, capable of solving the base station handover problem in the satellite ground fusion networks and satisfying quality of service requirements. The disclosed method is also applicable to scenarios involving mobile base stations in the network, solving the problem of handover between mobile base stations and between the mobile base stations and fixed base stations, and improving quality of service.

The disclosure also provides a network access control function (NACF), which will be described below with reference to FIG. 6.

FIG. 6 is a schematic structure diagram of a network access control function in some embodiments of the present disclosure. As shown in FIG. 6, the NACF 60 of the embodiment comprises: a receiving module 610, a determining module 620, and a sending module 630.

The receiving module 610 is configured to receive base station status information sent from each of a plurality of base stations. The receiving module can be implemented by a NACF receiver.

The determining module 620 is configured to determine a handover priority for the each of the plurality of base stations based on the base station status information the each of the plurality of base stations; The determining module can be implemented by a NACF controller.

The sending module 630 is configured to send to the each of the plurality of base stations the handover priority of a relevant base station. The sending module can be implemented by a NACF transmitter.

In some embodiments, the base station status information comprises: at least one of base station location, satellite ephemeris information, constellation trajectory, load information, or quality of service information.

In some embodiments, the NACF 60 further comprises: a storage module 640 is configured to store the base station status information and the handover priority of the each of the plurality of base stations. The storage module can be implemented by a the NACF memory.

In some embodiments, the receiving module 610 is further configured to receive updated base station status information sent from one or more updated base stations, wherein the one or more updated base stations are part or all of the plurality of base stations; the determining module 620 is further configured to determine an updated handover priority for the each of the plurality of base stations based on the updated base station status information of each of the one or more updated base stations and the base station status information of each non-updated base station; the sending module 630 is further configured to send to the each of the plurality of base stations the updated handover priority of the relevant base station of the each of the plurality of base stations. The storage module 640 is further configured to store the updated base station status information and the updated handover priority of the each of the plurality of base stations to update the stored base station status information and the handover priority of the each of the plurality of base stations.

In some embodiments, the receiving module 610 is further configured to receive an information retransmission request sent from a source base station of handover, wherein the source base station is a base station among the plurality of base stations, and the information retransmission request is configured to request the base station status information of a relevant base station of the source base station; the storage module 640 is further configured to query the base station status information of the relevant base station of the source base station; the sending module 630 is further configured to send queried information to the source base station to enable the source base station to select a target base station for handover based on received information.

In some embodiments, the relevant base station of the each of the plurality of base stations comprise: one or more nearby base stations within a predetermined distance from the each of the plurality of base stations.

In some embodiments, the information retransmission request is sent from the source base station in a case where a current handover policy is inconsistent with a policy generating the handover priority of the each of the plurality of base stations.

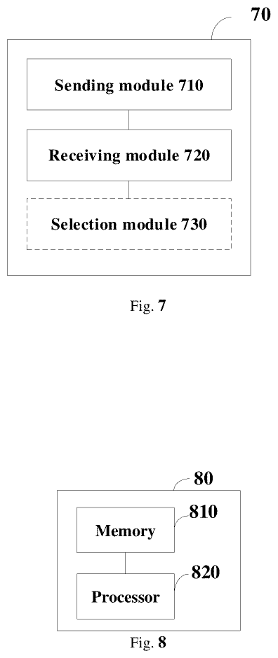

The disclosure also provides a base station, which will be described below with reference to FIG. 7.

FIG. 7 is a schematic structure diagram of a base station in some embodiments of the present disclosure. As shown in FIG. 7, the base station 70 of the embodiment comprises a sending module 710 and a receiving module 720.

The sending module 710 is configured to send base station status information to a network access control function (NACF), wherein the base station status information is used by the NACF to determine a handover priority for each of a plurality of base stations. The sending module can be implemented by a transmitter of the base station.

The receiving module 720 is configured to receive and store the handover priority of a relevant base station of the each of the plurality of base stations sent from the NACF. The reception and storage functions of the receiving module can be implemented by a receiver and a memory of the base station.

In some embodiments, the sending module 710 is further configured to send updated base station status information to the NACF, wherein the updated base station status information is used by the NACF to determine an updated handover priority for the each of the plurality of base stations; the receiving module 720 is further configured to receive and store the updated handover priority of the relevant base station sent from the NACE.

In some embodiments, the base station 70 further comprises a selection module 730, the sending module 710 is configured to send, in a case where a handover decision is made and a current handover policy is inconsistent with a policy generating the handover priority of the each of the plurality of base stations, an information retransmission request to the NACF, wherein the information retransmission request is configured to request the base station status information of the relevant base station of the base station; the receiving module 720 is further configured to receive the base station status information of the relevant base station returned by the NACF; the selection module 730 is configured to select a target base station for handover based on the base station status information of the relevant base station. The selection module can be implemented by a controller of the base station.

In some embodiments, the selection module 730 is further configured to select a target base station for handover based on the handover priority of the relevant base station in the case where a handover decision is made.

In some embodiments, the relevant base station of the each of the plurality of base stations comprise: one or more nearby base stations within a predetermined distance from the each of the plurality of base stations.

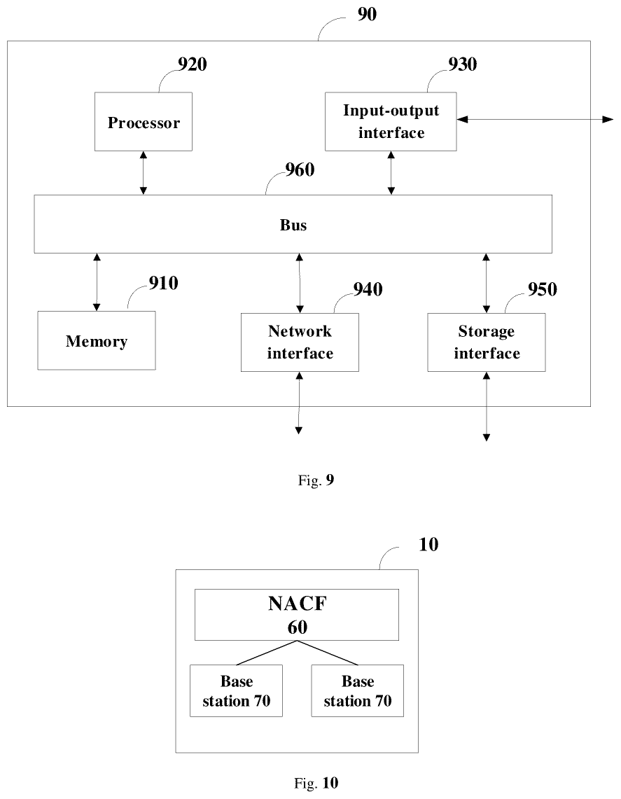

A electronic device (e.g., NACF or base station) of the embodiment of the present disclosure may be implemented by various computing devices or computer systems, which will be described below with reference to FIGS. 8 and 9.

FIG. 8 is a schematic structure diagram of an electronic device in some embodiments of the present disclosure. As shown in FIG. 8, the electronic device 80 of the embodiment comprises: a memory 810 and a processor 820 coupled to the memory 810, the processor 820 configured to, based on instructions stored in the memory 810, carry out a method for processing information of a base station in any one of the embodiments of the present disclosure.

Wherein, the memory 810 may comprise, for example, a system memory, a fixed non-volatile storage medium, or the like. The system memory stores, for example, an operating system, applications, a boot loader, a database, and other programs.

FIG. 9 is a schematic structure diagram of an electronic device in some other embodiments of the present disclosure. As shown in FIG. 9, the electronic device 90 of the embodiment comprises: a memory 910 and a processor 920 that are similar to the memory 810 and the processor 820, respectively. The electronic device 90 may further comprise an input-output interface 930, a network interface 940, a storage interface 950, and the like. These interfaces 930, 940, 950, the memory 910 and the processor 920 may be connected through a bus 960, for example. Wherein, the input-output interface 930 provides a connection interface for input-output devices such as a display, a mouse, a keyboard, and a touch screen. The network interface 940 provides a connection interface for various networked devices. For example, the network interface 940 can be connected to a database server or a cloud storage server. The storage interface 950 provides a connection interface for external storage devices such as an SD card and a USB flash disk.

The present disclosure also provides a system for processing information of a base station, which will be described below with reference to FIG. 10.

FIG. 10 is a schematic structure diagram of a system for processing information of a base station in some embodiments of the present disclosure. As shown in FIG. 10, the system 10 of the embodiment comprises: a NACF 60 and one or more base stations 70 provided in any one of the foregoing embodiments.

Those skilled in the art should understand that the embodiments of the present disclosure may be provided as a method, a system, or a computer program product. Therefore, the embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (comprising but not limited to disk storage, CD-ROM, optical storage device, etc.) having computer-usable program code embodied therein.

The present disclosure is described with reference to flowcharts and/or block diagrams of method, device (system) and computer program product according to the embodiments of the present disclosure. It should be understood that each flow and/or block in the flowcharts and/or block diagrams, and combinations of the flow(s) and/or block(s) in the flowcharts and/or block diagrams can be realized by computer program instructions. These computer program instructions may be provided to a processor of a general-purpose computer, special-purpose computer, embedded processor, or other programmable data processing apparatus to generate a machine such that the instructions executed by the processor of the computer or other programmable data processing apparatus to generate device for implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture comprising instruction device implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

The above is merely preferred embodiments of the disclosure, and is not limitation to the disclosure. Within spirit and principles of the disclosure, any modification, replacement, improvement and etc. shall be contained in the protection scope of the disclosure.

1. A method for processing information of a base station, which is performed by a network access control function (NACF) and comprises:
receiving base station status information sent from each of a plurality of base stations;
determining a handover priority for the each of the plurality of base stations based on the base station status information of the each of the plurality of base stations; and
sending to the each of the plurality of base stations the handover priority of a relevant base station of the each of the plurality of base stations.

2. The information processing method according to claim 1, wherein the base station status information comprises: at least one of constellation trajectory, load information, base station location, satellite ephemeris information, or quality of service information.

3. The information processing method according to claim 1- or 2, further comprising:
storing the base station status information and the handover priority of the each of the plurality of base stations.

4. The information processing method according to claim 1, further comprising:
receiving updated base station status information sent from one or more updated base stations, wherein the one or more updated base stations are part or all of the plurality of base stations;
determining an updated handover priority for the each of the plurality of base stations based on the updated base station status information of each of the one or more updated base stations and the base station status information of each non-updated base station; and
sending to the each of the plurality of base stations the updated handover priority of the relevant base station of the each of the plurality of base stations.

5. The information processing method according to claim 4, further comprising:
storing the updated base station status information and the updated handover priority of the each of the plurality of base stations to update the stored base station status information and the handover priority of the each of the plurality of base stations.

6. The information processing method according to claim 1, further comprising:
receiving an information retransmission request sent from a source base station of handover, wherein the source base station is a base station among the plurality of base stations, and the information retransmission request is configured to request the base station status information of a relevant base station of the source base station;
querying the base station status information of the relevant base station of the source base station; and
sending queried information to the source base station to enable the source base station to select a target base station for handover based on received information.

7. The information processing method according to claim 1, wherein the relevant base station of the each of the plurality of base stations comprise: one or more nearby base stations within a predetermined distance from the each of the plurality of base stations.

8. The information processing method according to claim 6, wherein
the information retransmission request is sent from the source base station in a case where a current handover policy is inconsistent with a policy generating the handover priority of the each of the plurality of base stations.

9. A method for processing information of a base station, which is performed by a base station and comprises:
sending base station status information to a network access control function (NACF), wherein the base station status information is used by the NACF to determine a handover priority for each of a plurality of base stations; and
receiving and storing the handover priority of a relevant base station of the each of the plurality of base stations sent from the NACF.

10. The information processing method according to claim 9, further comprising:
sending updated base station status information to the NACF, wherein the updated base station status information is used by the NACF to determine an updated handover priority for the each of the plurality of base stations; and
receiving and storing the updated handover priority of the relevant base station sent from the NACF to update the stored handover priority of the relevant base station.

11. The information processing method according to claim 9, further comprising:
in a case where a handover decision is made and a current handover policy is inconsistent with a policy generating the handover priority of the each of the plurality of base stations, sending an information retransmission request to the NACF, wherein the information retransmission request is configured to request the base station status information of the relevant base station of the base station;
receiving the base station status information of the relevant base station returned by the NACF; and
selecting a target base station for handover based on the base station status information of the relevant base station.

12. The information processing method according to claim 9, further comprising:
in a case where a handover decision is made, selecting a target base station for handover based on the handover priority of the relevant base station.

13. The information processing method according to claim 9, wherein the relevant base station of the each of the plurality of base stations comprise: one or more nearby base stations within a predetermined distance from the each of the plurality of base stations.

14. (canceled)

15. (canceled)

16. A network access control function, comprising:
a processor; and
a memory coupled to the processor for storing instructions that, when executed by the processor, cause the processor to:
receive base station status information sent from each of a plurality of base stations;
determine a handover priority for the each of the plurality of base stations based on the base station status information of the each of the plurality of base stations; and
send to the each of the plurality of base stations the handover priority of a relevant base station of the each of the plurality of base stations.

17. A system for processing information of a base station, comprising: a network access control function according to claim 14 and one or more base stations, wherein:
each of the one or more base stations comprises a processor; and a memory coupled to the processor, for storing instructions that when executed by the processor, cause the processor to:
send base station status information to a network access control function (NACF), wherein the base station status information is used by the NACF to determine a handover priority for each of a plurality of base stations; and
receive and store the handover priority of a relevant base station of the each of the plurality of base stations sent from the NACF.

18. A base station, comprising:
a processor; and
a memory coupled to the processor for storing instructions that, when executed by the processor, cause the processor to perform a method for processing information of a base station according to claim 9.

19. The network access control function according to claim 16, wherein the base station status information comprises: at least one of constellation trajectory, load information, base station location, satellite ephemeris information, or quality of service information.

20. The network access control function according to claim 16, wherein the memory coupled to the processor for storing instructions that, when executed by the processor, cause the processor further to:
store the base station status information and the handover priority of the each of the plurality of base stations.

21. The network access control function according to claim 16, wherein the memory coupled to the processor for storing instructions that, when executed by the processor, cause the processor further to:
receive updated base station status information sent from one or more updated base stations,
